(19) United States
(12) Patent Application Publication
(10) Pub. No.: US 2025/0074138 A1
(43) Pub. Date: Mar. 6, 2025

(54) HEATING MODULE FOR RECREATIONAL VEHICLES

(71) Applicant: ZHONGSHAN POWTEK APPLIANCES MFG., LTD., Zhongshan (CN)

(72) Inventors: Xianwei FENG, Zhongshan (CN); Tanghui ZHU, Zhongshan (CN); Song LIU, Zhongshan (CN); Yingheng TIAN, Zhongshan (CN)

(21) Appl. No.: 18/391,458

(22) Filed: Dec. 20, 2023

(30) Foreign Application Priority Data
Aug. 30, 2023 (CN) 202322345008.9

(51) Int. Cl. B60H 1/00; B60H 1/22; B60R 15/02

(52) U.S. Cl. CPC B60H 1/00328; B60H 1/22; B60R 15/02; B60H 2001/224; B60H 2001/2246; B60H 2001/2278

(57) ABSTRACT

A heating module for recreational vehicles (RVs), including a heat exchanger, a heating water inlet, a heating water outlet and a cold water inlet. The heat exchanger is communicated with the heating water inlet. A side of the heat exchanger is provided with a fan to generate air flow, so as to carry the heat generated by the heat exchanger to an interior of the RV. The heating water inlet is communicated with a water outlet of a water heater. The heating water outlet is connected with the heat exchanger, and a water pump is provided on a pipeline between the heating water outlet and the heat exchanger. The cold water inlet is configured to be connected with tap water or a water storage tank of the RV. A water flow sensor is provided on the cold water inlet.

### CROSS-REFERENCE TO RELATED APPLICATIONS

This application claims the benefit of priority from Chinese Patent Application No. 202322345008.9, filed on Aug. 30, 2023. The content of the aforementioned application, including any intervening amendments thereto, is incorporated herein by reference in its entirety.

### TECHNICAL FIELD

This application relates to gas water heaters and gas heating boilers, and more particularly to a heating module for recreational vehicles with a water heater as a heat source.

### BACKGROUND

Most of the commercially-available recreational vehicles (RVs) are only equipped with a water heater, which is only used for showering and cannot provide the heating function, so the RVs is not suitable for places with low temperature, thereby limiting the application range and bringing great inconvenience. A heating module for RVs can be compatible with an equipped water heater, and the water heater is used as a heat source to heat the RV without affecting its showering function.

### SUMMARY

The present disclosure provides a heating module for recreational vehicles (RVs), which can cooperate with a water heater. Hot water generated by the water heater passes through a copper tube in a heat exchanger of the heating module, and a fan is operated to drive cold wind to pass through an outside of the heat exchanger to undergo heat exchange. After that, the cold wind is converted into hot wind, and the hot wind is transported through an air outlet on a top of the heating module to heat the RV.

In order to arrive at the above purposes, technical solutions of the present disclosure are described as follows.

This application provides a heating module for recreational vehicles (RVs), comprising:
a heat exchanger;
a heating water inlet;
a heating water outlet; and
a cold water inlet;
wherein the heat exchanger is communicated with the heating water inlet; a side of the heat exchanger is provided with a fan; the fan is configured to generate an air flow to carry heat generated by the heat exchanger to an interior of an RV; and the heating water inlet is communicated with a water outlet of a vehicle-mounted water heater; the heating water outlet is connected with the heat exchanger, and a water pump is provided on a pipeline between the heating water outlet and the heat exchanger; the cold water inlet is configured to be connected with tap water or a water storage tank of the RV; and a water flow sensor is provided on the cold water inlet.

In an embodiment, the heating module further includes a controller. The controller is electrically connected with the fan and the water pump. And the controller is also electrically connected with a temperature sensor in the RV.

In an embodiment, a check valve is arranged on the heating water outlet.

In an embodiment, a check valve is arranged on the cold water inlet.

The operation flow during the heating state: the temperature sensor detects that temperature meets a condition for starting the heating→starting the water pump→the water heater detects a water flow signal to start ignition→starting the fan, and the fan continuously sends the hot wind for heating→the temperature sensor detects that the temperature reaches a preset value→the water pump and the fan are stopped.

The operation flow during the showering state: cold water flows through the water flow sensor of the heating module→detecting a water flow signal→stopping the operation of the water pump and the fan, and the cold water is normally heated through the water heater for showering.

Compared to the prior art, the present disclosure has the following beneficial effects.
(1) The heating module can be directly introduced to the RV equipped with a water heater without changing a structure of the existing water heater.
(2) The heating module can cooperate with the RV water heater to additionally provide the heating function without affecting the showering experience.
(3) The heating module is compatible with the existing RV water heater, and does not need to introduce an additional heat source.
(4) The electric heating (such as an air conditioner) has a large power consumption, and it fails to ensure the timely power supply outdoors. By comparison, the heating module proposed herein utilizes the water heater as a heating source for heating, and the replenishment of liquefied gas is more convenient. Moreover, compared to one power charging, the one replenishment of the liquefied gas can perform heating for a longer period of time.
(5) The heating module does not need connection to an additional gas source, thereby reducing security risks.

### BRIEF DESCRIPTION OF THE DRAWINGS

FIG. 1 schematically shows a structure of a heating module for recreational vehicles according to an embodiment of the present disclosure.

### DETAILED DESCRIPTION OF EMBODIMENTS

The present disclosure will be clearly and completely described below with reference to the embodiments and accompanying drawings. It's obvious that described herein are only some embodiments rather than all embodiments of the disclosure.

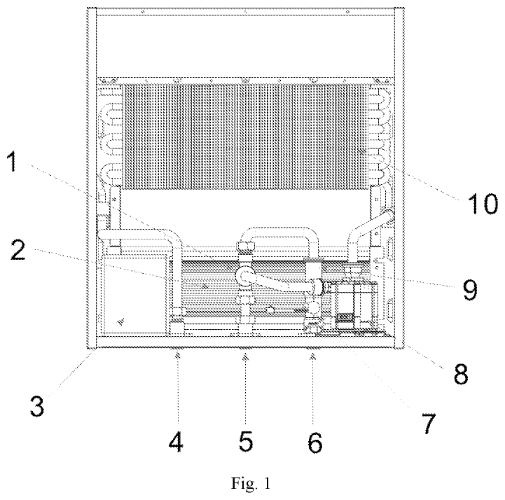

Referring to FIG. 1, the present disclosure provides a heating module for recreational vehicles (RVs), including a heat exchanger 10 and a heating water inlet 4. The heat exchanger 10 is communicated with the heating water inlet 4. A side of the heat exchanger 10 is provided with a fan 2; the fan 2 is configured to generate an air flow to carry heat generated by the heat exchanger 10 into an RV. The heating water inlet 4 is communicated with a water outlet of a vehicle-mounted water heater. The heating module further includes a heating water outlet 5 and a cold water inlet 6. The heating water outlet 5 is connected with the heat exchanger 10, and a water pump 8 is arranged on a pipeline between the heating water outlet 5 and the heat exchanger 10. The cold water inlet 6 is configured to be connected with tap water or a water storage tank of the RV. And a water flow sensor 7 is provided on the cold water inlet 6.

In an embodiment, the heating module further includes a controller 3. The controller 3 is electrically connected with the fan 2 and the water pump 8. The controller 3 is also electrically connected with a temperature sensor in the RV. And the heating module can realize automatic operation through a connection between the controller 3 and the temperature sensor.

In an embodiment, a first check valve 1 is arranged on the heating water outlet 5, and a second check valve 9 is arranged on the cold water inlet 6.

The operation flow during the heating state: the temperature sensor detects that temperature meets a condition for starting the heating→the water pump 8 is started→the water heater detects a water flow signal to start ignition→the fan 2 is started, and the fan 2 continuously sends the hot wind for heating→the temperature sensor detects that the temperature reaches a present value→the water pump 8 and the fan 2 are stopped.

The operation flow during the showering state: cold water flows through the water flow sensor 7 of the heating module→a water flow signal is detected→the operation of the water pump 8 and the fan 2 are stopped, and the cold water is normally heated through the water heater for showering.

Referring to FIG. 1, the heating water inlet 4 is connected with a water outlet of the water heater, and the heating water outlet 5 is connected with the water inlet of the water heater. The cold water inlet 6 is connected with the tap water or the water storage tank of the RV. A water flow direction of water in the first check valve 1 and the second check valve 9 is to the heating water outlet 5, and a reverse direction can not flow, so as to effectively avoid backflow of heating and bathroom. The water flow sensor 7 can determine whether there is a demand for domestic hot water, if yes, the water pump 8 and the fan 2 are stopped.

It can be seen that the heating module provided herein effectively solves the heating problems of the RVs without affecting the normal showering operation, which greatly improves the users' experience.

It should be noted that the orientation or position relationships indicated by the terms “up”, “down”, “left”, “right”, “front”, “back” and so on are only used to describe the relative positional relationship or movement in a particular attitude (as shown in the accompanying drawings), and if the particular attitude changes, the directional indication accordingly changes.

Besides, the terms “first” and “second” are only used for description, and can't be understood as indicating or implying relative importance, or implying and indicating the number of referred technical features. Therefore, once a feature is defined with “first” or “second”, it may expressly or impliedly indicate the presence of one or more of such features. As used herein, “multiple” means two, three or more unless otherwise clearly stated.

As used herein, unless otherwise expressly specified and limited, the terms “connection”, “linkage” and “fixing” should be interpreted in a broad sense. For example, it can be “fixed connection”, “removable connection” or “integral connection”; it can be “mechanical connection” or “electrical connection”; it can be “direct connection” or “indirect connection through an intermediate medium”; and it can be internal communication or interaction between two components. For those of ordinary skill in the art, the specific meaning of these terms can be understood in specific cases.

The technical solutions of individual embodiments of the present disclosure can be combined with each other as long as the combined solution can be implemented by those skilled in the art. When the combination is contradictory or cannot be realized, it shall be considered that such combination does not exist, and is not within the scope of this disclosure defined by the appended claims.

What is claimed is:

1. A heating module for recreational vehicles (RVs), comprising:
a heat exchanger;
a heating water inlet;
a heating water outlet; and
a cold water inlet;
wherein the heat exchanger is communicated with the heating water inlet; a side of the heat exchanger is provided with a fan; the fan is configured to generate an air flow to carry heat generated by the heat exchanger to an interior of an RV; and the heating water inlet is communicated with a water outlet of a vehicle-mounted water heater;
the heating water outlet is connected with the heat exchanger, and a water pump is provided on a pipeline between the heating water outlet and the heat exchanger; and
the cold water inlet is configured to be connected with tap water or a water storage tank of the RV; and a water flow sensor is provided on the cold water inlet.

2. The heating module of claim 1, further comprising:
a controller;
wherein the controller is electrically connected with the fan and the water pump; and the controller is also electrically connected with a temperature sensor in the RV.

3. The heating module of claim 1, wherein a check valve is arranged on the heating water outlet.

4. The heating module of claim 1, wherein a check valve is arranged on the cold water inlet.
